(19) United States
(12) Patent Application Publication
(10) Pub. No.: US 2026/0228798 A1
(43) Pub. Date: Aug. 6, 2026

(54) COMMUNICATIONS SERVER APPARATUS, METHOD AND COMMUNICATIONS SYSTEM FOR RECOMMENDING ONE OR MORE POINTS-OF-INTEREST FOR A TRANSPORT-RELATED SERVICE TO A USER

(71) Applicant: GRABTAXI HOLDINGS PTE. LTD., Singapore (SG)

(72) Inventors: Qing FAN, Beijing (CN); Lang JIAO, Beijing (CN); Chengcheng DAI, Beijing (CN); Ziqiang DENG, Beijing (CN); Rui ZHANG, Beijing (CN)

(73) Assignee: GRABTAXI HOLDINGS PTE. LTD., Singapore (SG)

(21) Appl. No.: 19/654,178

(22) Filed: Apr. 21, 2026

Related U.S. Application Data
(63) Continuation of application No. 17/607,268, filed on Apr. 29, 2019.

(51) Int. Cl. G06Q 30/0601; G01C 21/34; G01C 21/36

(52) U.S. Cl. CPC G06Q 30/0631; G01C 21/3438; G01C 21/3617; G01C 21/3694

(57) ABSTRACT

Provided are communications server apparatus for recommending one or more points-of-interest (POIs) for a transport-related service to a user, such as when the user wish to request or make a booking for a transport-related service. The POIs are recommended at different actions/scenarios or at different stages of the booking, based on a plurality of data/information, which may be from a plurality of data sources. Recommendation may be done using data relating to one or more pairings of origin locations and destination locations corresponding to historical transport-related services, or using historical data and data corresponding to top ranking points-of-interest in at least one destination category in a geographical area, or based on resultant scores of candidate POIs that are determined from individual scores assigned to a plurality of criteria for the candidate POIs, where the individual scores for at least some of the criteria are determined based on historical data.

### TECHNICAL FIELD

The invention relates generally to the field of communications. One aspect of the invention relates to a communications server apparatus for recommending one or more points-of-interest for a transport-related service to a user. Other aspects of the invention relate to further communications server apparatus for recommending one or more points-of-interest for a transport-related service to a user, methods for recommending one or more points-of-interest for a transport-related service to a user, communications systems for recommending one or more points-of-interest for a transport-related service to a user, and a communications server device for recommending one or more points-of-interest for a transport-related service to a user. Further aspects relate to computer program products, computer programs and non-transitory storage media having instructions for implementing any one of the methods described herein.

One aspect of the invention has particular, but not exclusive, application for recommending one or more points-of-interest for a transport-related service to a user. For example, the user may wish to request or make a booking for a transport-related service, e.g., a ride-hailing transport service, and the techniques disclosed may provide, for different actions/scenarios or at different stages of the booking, recommendation of one or more points-of-interest as origin locations and/or destination locations corresponding to the transport-related service for the purpose of the booking. The user may use a corresponding Application or “App” for making the booking, and the recommended points-of-interest may be provided or presented to the user via the App for consideration and/or selection.

### BACKGROUND

In response to user query for transport services, searching for POIs (Point-Of-Interest) in relation to the query is carried out. However, the current quality of POI service is not satisfactory as known approaches for transport services filter POIs according to the user's location only without consideration of other requirements or attributes.

### SUMMARY

Aspects of the invention are as set out in the independent claims. Some optional features are defined in the dependent claims.

Implementation of the techniques disclosed herein may provide significant technical advantages. The techniques may enable recommendation of one or more points-of-interest (POIs) for a transport-related service to a user based on a plurality of data/information, which, for example, may be from a plurality of data sources.

In at least some implementations, the techniques disclosed herein may provide recommendation of one or more points-of-interest (POIs) based on historical data, for example, data relating to one or more pairings of origin locations and destination locations corresponding to historical transport-related services.

In at least some implementations, the techniques disclosed herein allow for recommendation of one or more points-of-interest (POIs) based on historical data and data corresponding to top ranking points-of-interest in at least one destination category in a geographical area (e.g., a city).

In at least some implementations, the techniques disclosed herein may provide recommendation of one or more points-of-interest (POIs) based on resultant scores of candidate POIs that may be determined from individual scores assigned to a plurality of criteria for the candidate POIs. The individual scores for at least some of the criteria may be determined based on historical data.

In at least some implementations, the techniques disclosed herein may provide recommendation of one or more points-of-interest (POIs) for different actions/scenarios during booking of a transport-related service, where these actions may occur in a sequential order.

In an exemplary implementation, the functionality of the techniques disclosed herein may be implemented in software running on a handheld communications device, such as a mobile phone. The software which implements the functionality of the techniques disclosed herein may be contained in an “App”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel for recommending one or more points-of-interest (POIs) for a transport-related service to a user.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a communications server apparatus for recommending one or more points-of-interest for a transport-related service to a user.

FIG. 2B shows a flow chart illustrating a method performed in a communications server apparatus for recommending one or more points-of-interest for a transport-related service to a user.

FIG. 2C shows a schematic block diagram illustrating a communications server apparatus for recommending one or more points-of-interest for a transport-related service to a user.

FIG. 2D shows a flow chart illustrating a method performed in a communications server apparatus for recommending one or more points-of-interest for a transport-related service to a user.

FIG. 2E shows a schematic block diagram illustrating a communications server apparatus for recommending one or more points-of-interest for a transport-related service to a user.

FIG. 2F shows a schematic block diagram illustrating a data record.

FIG. 2G shows a flow chart illustrating a method performed in a communications server apparatus for recommending one or more points-of-interest for a transport-related service to a user.

FIG. 2H shows a schematic block diagram illustrating a communications server device for recommending one or more points-of-interest for a transport-related service to a user.

FIG. 2I shows a flow chart illustrating a method performed in a communications server device for recommending one or more points-of-interest for a transport-related service to a user.

FIGS. 3A to 3D illustrate the 4 major scenarios of the POI (point-of-interest) Service of various embodiments.

FIG. 4 shows a schematic diagram illustrating a layer-based web service structure.

FIG. 5 shows a schematic diagram illustrating an overview of the system for POI (point-of-interest) service.

FIG. 6 shows an example of a plot of time distribution of a POI (point-of-interest).

FIGS. 7A to 7D show the performance of the POI service of various embodiments in scenarios Predict, Suggest, Search and ReverseGeo respectively.

### DETAILED DESCRIPTION

The present techniques may provide point-of-interest (POI) recommendation in real time, for example, Golang-based POI discovery and recommendation in real time.

One aspect of transport services (e.g., ride-hailing transport services) is to provide users with the desired POIs as pickups and/or drop-offs based on their locations with as less effort as possible, which can be measured by the clicking times on the screen by a user before clicking the booking button. As a geo-based service, POI discovery and recommendation may involve a lot of geometric calculation and high traffic throughput. It is important to ensure the high availability and stability of POI discovery and recommendation. In the present techniques, a Golang-based service architecture has been adapted to ensure the stability of the backend system. Elastic search may be utilised to organise millions of POI data on the database layer. Redis may be used to shorten the response time of each request as cache. As will be described further below, a Golang-based service architecture may be employed and online challenges may be addressed by deploying techniques such as Elastic Search and Redis according to the various scenarios. The POI service may help increase the ratio of completed bookings with average of quite small times of clicking on the screen.

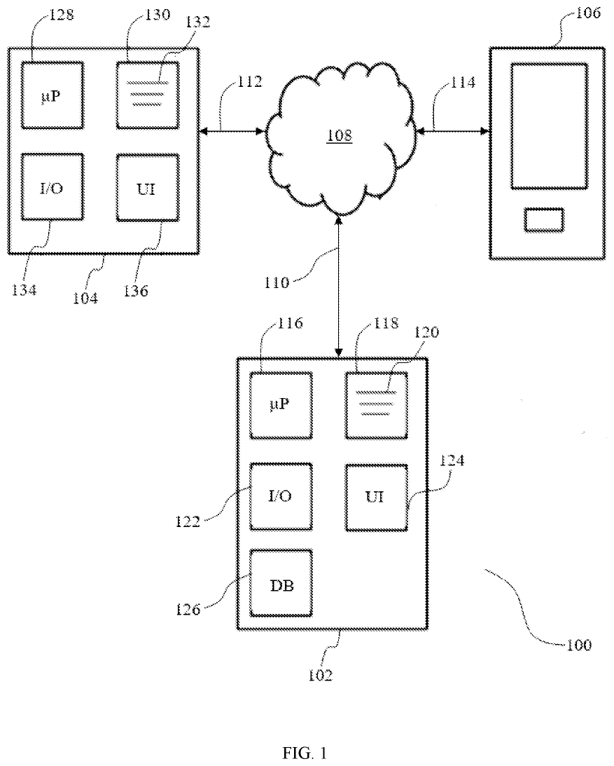

Referring first to FIG. 1, a communications system 100 is illustrated, which may be applicable in various embodiments. The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be for recommending one or more points-of-interest (POIs) for a transport-related service to a user.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (P) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The user communications device 104 may include a number of individual components including, but not limited to, one or more microprocessors (P) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like.

The user communications device 106 may be, for example, a smart phone or tablet device with the same or a similar hardware architecture to that of the user communications device 104.

The user communications device 104 and/or the user communications device 106 may be for receiving information or data in relation to one or more recommended points-of-interest (POIs) for a transport-related service to a user.

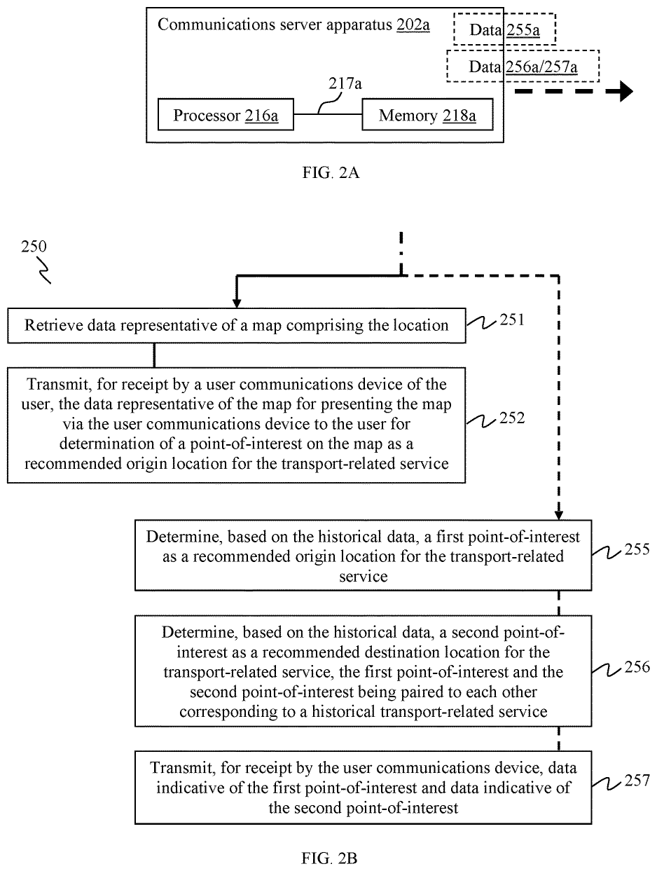

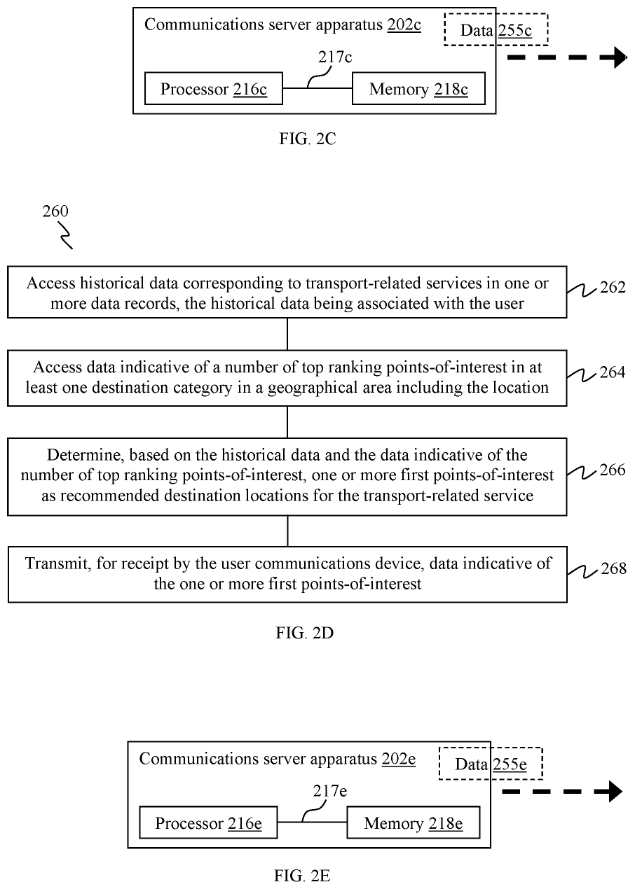

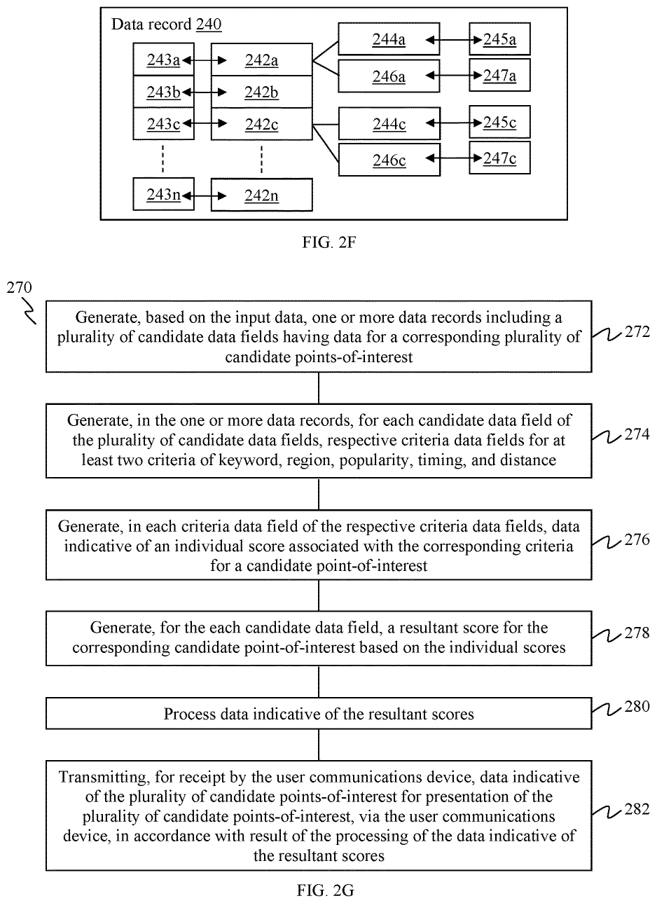

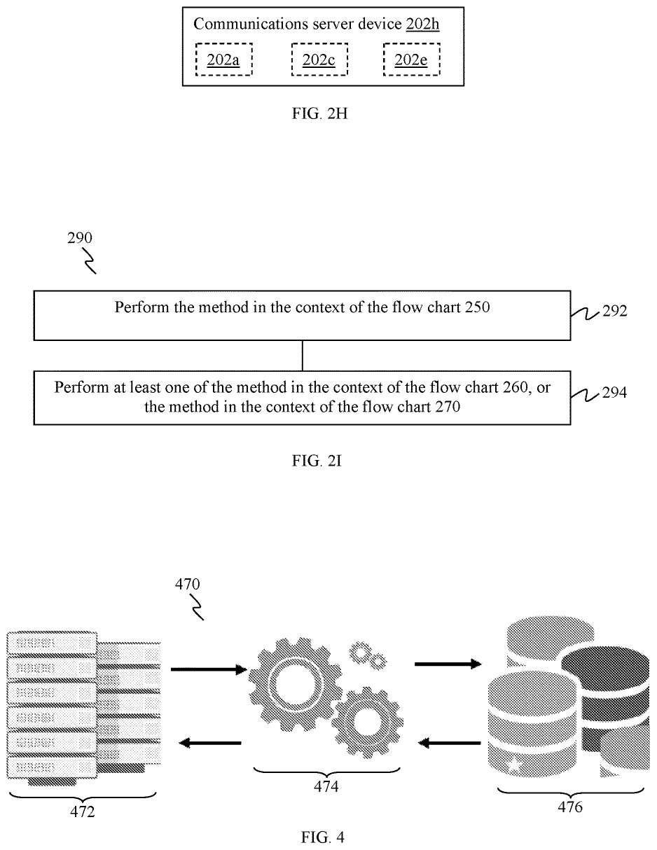

FIG. 2A shows a schematic block diagram illustrating a communications server apparatus 202a for recommending one or more points-of-interest (POIs) for a transport-related service to a user. The communications server apparatus 202a includes a processor 216a and a memory 218a, where the communications server apparatus 202a is configured, under control of the processor 216a, to execute instructions in the memory 218a to, in response to receiving user data including a data field indicative of a location (e.g., data indicative of a latitude (lat) value and a longitude (lng) value) of the user (e.g., a current location or projected location) and further in response to the communications server apparatus 202a determining that there is no historical data associated with the user corresponding to transport-related services, retrieve data 255a representative of a map having the location, and transmit, for receipt by a user communications device of the user, the data 255a representative of the map for presenting the map via the user communications device to the user for determination (e.g., based on the location of the user) of a (single) point-of-interest on the map as a recommended origin location (or pickup location) for the transport-related service, and in response to the communications server apparatus 202a determining that there is historical data corresponding to transport-related services in one or more data records, the historical data being associated with the user, determine, based on the historical data, a (single) first point-of-interest as a recommended origin location (or pickup location) for the transport-related service, determine, based on the historical data, a (single) second point-of-interest as a recommended destination location (or dropoff location) for the transport-related service, the first point-of-interest and the second point-of-interest being paired to each other corresponding to a historical transport-related service, and, transmit, for receipt by the user communications device, data 256a indicative of the first point-of-interest and data 257a indicative of the second point-of-interest.

The processor 216a and the memory 218a may be coupled to each other (as represented by the line 217a), e.g., physically coupled and/or electrically coupled. The processor 216a may be as described in the context of the processor 116 (FIG. 1) and/or the memory 218a may be as described in the context of the memory 118 (FIG. 1).

The user data may further include another data field indicative of an identifier representative of the identity of the user (e.g., user ID).

In various embodiments, in response to the communications server apparatus 202a determining that there is the historical data and further in response to receiving user data (which may be the same user data having the data field indicative of the location of the user) having a data field indicative of a time (point) (e.g., current time (point) or projected time (point) or scheduled time (point)), for determining the second point-of-interest as the recommended destination location, the communications server apparatus 202a may be further configured to determine, based on the historical data, the second point-of-interest being paired to the first point-of-interest in a predetermined time interval (e.g., by hours in a day) including the time. The time may be, for example, the time that a booking is made, or the start time for a transport-related service.

As a non-limiting example, the time may be 3:05 pm, and the second point-of-interest that is paired to the first point-of-interest for a time interval of, say, 3:00-3:30 pm or 3:00-4:00 μm in the past (e.g., over the past 24 hours or a longer period of time), may be determined as the recommended destination location.

In various embodiments, in response to the communications server apparatus 202a determining that there is the historical data and further in response to receiving the user data including the data field indicative of the location of the user, for determining the first point-of-interest, the communications server apparatus 202a may be configured to determine whether there is data indicative of one or more historical origin locations for transport-related services included in the historical data, if it is determined that there is the data indicative of the one or more historical origin locations, define, based on the data indicative of the one or more historical origin locations, a historical origin location that is the closest in distance to the location of the user as the first point-of-interest, and transmit, for receipt by the user communications device, data indicative of the historical origin location, and if it is determined that there is no data indicative of the one or more historical origin locations, determine data indicative of one or more historical destination locations (or one or more last dropoff firsts (LDFs)) included in the historical data, define, based on the data indicative of the one or more historical destination locations, a historical destination location that is the closest in distance to the location of the user as the first point-of-interest, and transmit, for receipt by the user communications device, data indicative of the historical destination location.

In various embodiments, for determining the data indicative of the one or more historical destination locations, the communications server apparatus 202a may be configured to determine the data indicative of the one or more historical destination locations associated with a predetermined historical period of time (e.g., last 24 hours).

FIG. 2B shows a flow chart 250 illustrating a method performed in a communications server apparatus for recommending one or more points-of-interest for a transport-related service to a user, and under control of a processor of the communications server apparatus.

In response to receiving user data including a data field indicative of a location of the user and further in response to determining that there is no historical data associated with the user corresponding to transport-related services, at 251, data representative of a map having the location is retrieved, and, at 252, the data representative of the map is transmitted, for receipt by a user communications device of the user, for presenting the map via the user communications device to the user for determination of a point-of-interest on the map as a recommended origin location for the transport-related service.

In response to determining that there is historical data corresponding to transport-related services in one or more data records, the historical data being associated with the user, at 255, a first point-of-interest is determined, based on the historical data, as a recommended origin location for the transport-related service, at 256, a second point-of-interest is determined, based on the historical data, as a recommended destination location for the transport-related service, the first point-of-interest and the second point-of-interest being paired to each other corresponding to a historical transport-related service, and, at 257, data indicative of the first point-of-interest and data indicative of the second point-of-interest are transmitted, for receipt by the user communications device.

In response to determining that there is the historical data and further in response to receiving user data including a data field indicative of a time, at 256, the method may include determining, based on the historical data, the second point-of-interest being paired to the first point-of-interest in a predetermined time interval including the time.

In various embodiments, at 255, in response to determining that there is the historical data and further in response to receiving the user data including the data field indicative of the location of the user, the method may include determining whether there is data indicative of one or more historical origin locations for transport-related services included in the historical data, if it is determined that there is the data indicative of the one or more historical origin locations, defining, based on the data indicative of the one or more historical origin locations, a historical origin location that is the closest in distance to the location of the user as the first point-of-interest, and transmitting, for receipt by the user communications device, data indicative of the historical origin location, and if it is determined that there is no data indicative of the one or more historical origin locations, determining data indicative of one or more historical destination locations included in the historical data, defining, based on the data indicative of the one or more historical destination locations, a historical destination location that is the closest in distance to the location of the user as the first point-of-interest, and transmitting, for receipt by the user communications device, data indicative of the historical destination location.

In various embodiments, for determining the data indicative of the one or more historical destination locations, the method may include determining the data indicative of the one or more historical destination locations associated with a predetermined historical period of time.

Various embodiments may further provide a communications system for recommending one or more points-of-interest for a transport-related service to a user, having a communications server apparatus (e.g., 202a, FIG. 2A), at least one user communications device and communications network equipment operable for the communications server apparatus and the at least one user communications device to establish communication with each other therethrough, wherein the at least one user communications device includes a first processor and a first memory, the at least one user communications device being configured, under control of the first processor, to execute first instructions in the first memory to transmit, for receipt by the communications server apparatus for processing, user data including a data field indicative of a location of the user, and wherein the communications server apparatus includes a second processor and a second memory, the communications server apparatus being configured, under control of the second processor, to execute second instructions in the second memory to, in response to receiving data indicative of the user data transmitted by the at least one user communications device and further in response to the communications server apparatus determining that there is no historical data associated with the user corresponding to transport-related services, retrieve data representative of a map including the location, and transmit, for receipt by the at least one user communications device, the data representative of the map for presenting the map via the user communications device to the user for determination of a point-of-interest on the map as a recommended origin location for the transport-related service, and in response to the communications server apparatus determining that there is historical data corresponding to transport-related services in one or more data records, the historical data being associated with the user, determine, based on the historical data, a first point-of-interest as a recommended origin location for the transport-related service, determine, based on the historical data, a second point-of-interest as a recommended destination location for the transport-related service, the first point-of-interest and the second point-of-interest being paired to each other corresponding to a historical transport-related service, and transmit, for receipt by the at least one user communications device, data indicative of the first point-of-interest and data indicative of the second point-of-interest.

It should be appreciated that descriptions in the context of the communications server apparatus 202a, the method as described in the context of the flow chart 250, and the corresponding communications system described above may be applicable to one another.

The techniques disclosed above in the context of the communications server apparatus 202a, the method as described in the context of the flow chart 250 and the corresponding communications system described above may correspond to the action/scenario “Predict” to be described further below. Further, said techniques may be carried out in response to activation or launch of, or detection (or determination) of activation or launch of, a (software) application (e.g., “App”) corresponding to the transport-related service, or carried out at the start of a process where the user makes a request or booking for the transport-related service.

FIG. 2C shows a schematic block diagram illustrating a communications server apparatus 202c for recommending one or more points-of-interest (POIs) for a transport-related service to a user. The communications server apparatus 202c includes a processor 216c and a memory 218c, where the communications server apparatus 202c is configured, under control of the processor 216c, to execute instructions in the memory 218c to, in response to receiving user data including a first data field indicative of a location (e.g., data indicative of a latitude (lat) value and a longitude (lng) value) of the user (e.g., a current location or projected location), and a second data field indicative of a user request corresponding to a destination location (or dropoff location), access historical data corresponding to transport-related services in one or more data records, the historical data being associated with the user, access data indicative of a number of top ranking points-of-interest (e.g., most popular POIs; in the top 3, top 5 or any other number) in at least one destination category (e.g., shopping destination, food establishment, transport hub, etc.) in a geographical area (e.g., city) including the location, determine, based on the historical data and the data indicative of the number of top ranking points-of-interest, one or more first points-of-interest as recommended destination locations for the transport-related service, and transmit, for receipt by the user communications device, data 255c indicative of the one or more first points-of-interest.

The processor 216c and the memory 218c may be coupled to each other (as represented by the line 217c), e.g., physically coupled and/or electrically coupled. The processor 216c may be as described in the context of the processor 116 (FIG. 1) and/or the memory 218c may be as described in the context of the memory 118 (FIG. 1).

The user data may further include another data field indicative of an identifier representative of the identity of the user (e.g., user ID).

The second data field indicative of the user request corresponding to a destination location may correspond to the user clicking on an input box or input data field of a (software) application (e.g., “App”) corresponding to the transport-related service (e.g., an input data field for a destination location).

In the context of various embodiments, the historical data may include data indicative of a number of historical destination locations, and/or data indicative of one or more preferences of the user.

In various embodiments, the historical data may include data indicative of a number of historical destination locations that are most frequented by the user (e.g., 3 most frequented locations, 5 most frequented locations or any other number), wherein, for accessing the historical data, the communications server apparatus 202c may be further configured to access the data indicative of the number of historical destination locations that are most frequented by the user, and, for determining the one or more first points-of-interest, the communications server apparatus 202c may be further configured to determine the one or more first points-of-interest based on the data indicative of the number of historical destination locations that are most frequented by the user and the data indicative of the number of top ranking points-of-interest.

The communications server apparatus 202c may be further configured to, in response to receiving user data (which may be the same user data described above or another user data) including a data field indicative of a user request corresponding to an origin location (or pickup location), determine, based on the historical data and the location, one or more second points-of-interest as recommended origin locations for the transport-related service, and transmit, for receipt by the user communications device, data indicative of the one or more second points-of-interest.

The historical data may include data indicative of a number of historical origin locations, and the one or more second points-of-interest may be determined based on the number of historical origin locations

The data field indicative of the user request corresponding to an origin location may correspond to the user clicking on an input box or input data field of a (software) application (e.g., “App”) corresponding to the transport-related service (e.g., an input data field for an origin location).

For determining the one or more second points-of-interest, the communications server apparatus 202c may be configured to determine the one or more second points-of-interest that are within a predetermined distance relative to the location of the user as recommended origin locations.

The communications server apparatus 202c may be further configured, for each of the one or more second points-of-interest, to transmit, for receipt by the user communications device, data indicative of a distance between the second point-of-interest and the location of the user.

FIG. 2D shows a flow chart 260 illustrating a method performed in a communications server apparatus for recommending one or more points-of-interest for a transport-related service to a user, and under control of a processor of the communications server apparatus.

In response to receiving user data including a first data field indicative of a location, and a second data field indicative of a user request corresponding to a destination location, at 262, historical data corresponding to transport-related services in one or more data records is accessed, the historical data being associated with the user, at 264, data indicative of a number of top ranking points-of-interest in at least one destination category in a geographical area having the location is accessed, at 266, one or more first points-of-interest are determined, based on the historical data and the data indicative of the number of top ranking points-of-interest, as recommended destination locations for the transport-related service, and, at 268, data indicative of the one or more first points-of-interest is transmitted, for receipt by the user communications device.

In various embodiments, the historical data may include data indicative of a number of historical destination locations that are most frequented by the user. At 262, the data indicative of the number of historical destination locations that are most frequented by the user is accessed, and, at 266, the one or more first points-of-interest are determined based on the data indicative of the number of historical destination locations that are most frequented by the user and the data indicative of the number of top ranking points-of-interest.

In response to receiving user data including a data field indicative of a user request corresponding to an origin location, the method may further include determining, based on the historical data and the location, one or more second points-of-interest as recommended origin locations for the transport-related service, and transmitting, for receipt by the user communications device, data indicative of the one or more second points-of-interest.

In various embodiments, the method may include determining the one or more second points-of-interest that are within a predetermined distance relative to the location of the user as recommended origin locations.

In various embodiments, the method may further include, for each of the one or more second points-of-interest, transmitting, for receipt by the user communications device, data indicative of a distance between the second point-of-interest and the location of the user.

Various embodiments may further provide a communications system for recommending one or more points-of-interest for a transport-related service to a user, having a communications server apparatus (e.g., 202c, FIG. 2C), at least one user communications device and communications network equipment operable for the communications server apparatus and the at least one user communications device to establish communication with each other therethrough, wherein the at least one user communications device includes a first processor and a first memory, the at least one user communications device being configured, under control of the first processor, to execute first instructions in the first memory to transmit, for receipt by the communications server apparatus for processing, user data including a first data field indicative of a location, and a second data field indicative of a user request corresponding to a destination location, and wherein the communications server apparatus includes a second processor and a second memory, the communications server apparatus being configured, under control of the second processor, to execute second instructions in the second memory to, in response to receiving data indicative of the user data transmitted by the at least one user communications device, access historical data corresponding to transport-related services in one or more data records, the historical data being associated with the user, access data indicative of a number of top ranking points-of-interest in at least one destination category in a geographical area comprising the location, determine, based on the historical data and the data indicative of the number of top ranking points-of-interest, one or more first points-of-interest as recommended destination locations for the transport-related service, and transmit, for receipt by the at least one user communications device, data indicative of the one or more first points-of-interest.

It should be appreciated that descriptions in the context of the communications server apparatus 202c, the method as described in the context of the flow chart 260, and the corresponding communications system described above may be applicable to one another.

The techniques disclosed above in the context of the communications server apparatus 202c, the method as described in the context of the flow chart 260 and the corresponding communications system described above may correspond to the action/scenario “Suggest” to be described further below. Further, said techniques may be carried out in a sequential order after the scenario “Predict”, e.g., in the event that the results obtained from the scenario “Predict” are not as expected or not satisfactory to the user making a request or booking for a transport-related service.

FIG. 2E shows a schematic block diagram illustrating a communications server apparatus 202e for recommending one or more points-of-interest (POIs) for a transport-related service to a user, while FIG. 2F shows a schematic block diagram illustrating a data record 240 that may be generated by the communications server apparatus 202e.

The communications server apparatus 202e includes a processor 216e and a memory 218e, where the communications server apparatus 202e is configured, under control of the processor 216e, to execute instructions in the memory 218e to, in response to receiving user data including a first data field indicative of a location (e.g., data indicative of a latitude (lat) value and a longitude (lng) value) of the user (e.g., a current location or projected location), and a second data field having input data indicative of information inputted by the user, the information being at least partially descriptive of a requested location by the user as an origin location or a destination location for the transport-related service, generate, based on the input data, one or more data records 240 having a plurality of candidate data fields 242a, 242b, 242c, to 242n having data 243a, 243b, 243c, to 243n for a corresponding plurality of candidate points-of-interest, generate, in the one or more data records 240, for each candidate data field of the plurality of candidate data fields 242a, 242b, 242c, to 242n, respective criteria data fields (illustrated, as a non-limiting example, respective criteria data fields 244a, 246a for the candidate data field 242a, and respective criteria data fields 244c, 246c for the candidate data field 242c) for at least two criteria of keyword, region, popularity, timing, and distance, generate, in each criteria data field of the respective criteria data fields (e.g., 244a, 246a, 244c, 246c) data indicative of an individual score associated with the corresponding criteria for a candidate point-of-interest (illustrated, as a non-limiting example, data 245a, 247c, 245c, 247c for respectively criteria data fields 244a, 246a, 244c, 246c).

For the keyword, the individual score is determined based on a similarity between the information and one or more words (e.g., full name, partial name(s), acronym(s)) descriptive of a name of the candidate point-of-interest. For the region, the individual score is determined based on a proximity between a first geographical region (e.g., a city) including the location of the user and a second geographical region (e.g., a city) including the candidate point-of-interest. For the popularity, based on historical data corresponding to transport-related services in one or more historical data records, the individual score is determined based on a number of time the candidate point-of-interest is historically selected (e.g., by any one or more users, i.e., not just inclusive of the user making the request for the transport-related service, but also take into consideration the preference(s) of other user(s)) as the requested location for historical transport-related services (e.g., number of time the candidate point-of-interest has been selected as a historical origin location (if the requested location is for an origin location) or as a historical destination location (if the requested location is for a destination location). For the timing, based on historical data corresponding to transport-related services in one or more historical data records (which may be the same historical data record(s) mentioned above), the historical data being associated with the user, the individual score is determined based on a probability of the candidate point-of-interest being selected by the user as the requested location (origin location or destination location) at a defined time (e.g., probability of the candidate point-of-interest being selected in the morning, in the evening, or during/for a defined hour, etc.). For the distance, the individual score is determined based on a distance between the location of the user and the candidate point-of-interest.

The communications server apparatus 202e is configured to generate, for the each candidate data field 242a, 242b, 242c, to 242n, a resultant score for the corresponding candidate point-of-interest based on the individual scores (determined for the at least two criteria), process data indicative of the resultant scores, and, transmit, for receipt by the user communications device, data 255e indicative of the plurality of candidate points-of-interest for presentation of the plurality of candidate points-of-interest, via the user communications device, in accordance with result of the processing of the data indicative of the resultant scores. In various embodiments, for the data 255e to be transmitted from the communications server apparatus 202e, the plurality of candidate points-of-interest may already be ordered in accordance with the result of the processing.

The processor 216e and the memory 218e may be coupled to each other (as represented by the line 217e), e.g., physically coupled and/or electrically coupled.

The processor 216e may be as described in the context of the processor 116 (FIG. 1) and/or the memory 218e may be as described in the context of the memory 118 (FIG. 1).

The user data may further include another data field indicative of an identifier representative of the identity of the user (e.g., user ID).

The communications server apparatus 202e may receive user data (which may be the same user data having the first and second data fields) including a data field indicative of a time (point) (e.g., current time (point) or projected time (point) or scheduled time (point)).

As a non-limiting example, the requested location may be represented or described by a full name having a string of 8 letters, and the information inputted may include part of the name (e.g., (just) the first 5 letters of the full 8 letters, the full name (i.e., 8 letters) or an acronym representative of the requested location.

It should be appreciated that there may be any number, y, of the candidate data fields, where y≥2 (i.e., 2 or more).

For processing the data indicative of the resultant scores, the communications server apparatus 202e may be configured, based on the data indicative of the resultant scores, to generate, in the one or more data records 240, ranking data indicative of an ordering of the plurality of candidate points-of-interest according to the resultant scores for the plurality of candidate points-of-interest (e.g., a descending order of the resultant scores), and, for transmitting the data, the communications server apparatus 202e may be configured to transmit the data 255e indicative of the plurality of candidate points-of-interest for presentation of the plurality of candidate points-of-interest, via the user communications device, in an order in accordance with the ranking data. In various embodiments, for the data 255e to be transmitted from the communications server apparatus 202e, the plurality of candidate points-of-interest may already be ordered in accordance with the ranking data.

For processing the data indicative of the resultant scores, the communications server apparatus 202e may be configured, based on the data indicative of the resultant scores and, for each candidate point-of-interest of the plurality of candidate points-of-interest, to compare the resultant score against a threshold value indicative of matching relevancy of the candidate point-of-interest to the requested location, and, for transmitting the data, the communications server apparatus 202e may be configured to transmit the data 255e indicative of the candidate points-of-interest having resultant scores determined to be equal to or above the threshold value.

For generating the resultant score, the communications server apparatus 202e may be configured to generate the resultant score by weighted sum of the individual scores.

In various embodiments, the at least two criteria may include the region, and, in response to the individual score for the region being determined to be indicative of the first geographical region and the second geographical region being in different countries, the communications server apparatus 202e may be further configured to exclude (or disregard) the candidate point-of-interest.

For generating the respective criteria data fields (e.g., 244a, 246a, 244c, 246c), the communications server apparatus 202e may be configured to generate, for the each candidate data field 242a, 242b, 242c, to 242n, respective criteria data fields for at least three criteria of the keyword, the region, the popularity, the timing and the distance.

For generating the respective criteria data fields (e.g., 244a, 246a, 244c, 246c), the communications server apparatus 202e may be configured to generate, for the each candidate data field 242a, 242b, 242c, to 242n, respective criteria data fields for at least four criteria of the keyword, the region, the popularity, the timing and the distance.

In various embodiments, in response to the information being at least partially descriptive of the requested location as the origin location, for generating the respective criteria data fields e.g., 244a, 246a, 244c, 246c), the communications server apparatus 202e may be configured to generate, for the each candidate data field 242a, 242b, 242c, to 242n, respective criteria data fields for all criteria of the keyword, the region, the popularity, the timing and the distance.

FIG. 2G shows a flow chart 270 illustrating a method performed in a communications server apparatus for recommending one or more points-of-interest for a transport-related service to a user, and under control of a processor of the communications server apparatus.

In response to receiving user data including a first data field indicative of a location of the user, and a second data field having input data indicative of information inputted by the user, the information being at least partially descriptive of a requested location by the user as an origin location or a destination location for the transport-related service, at 272, one or more data records are generated, based on the input data, including a plurality of candidate data fields having data for a corresponding plurality of candidate points-of-interest. At 274, for each candidate data field of the plurality of candidate data fields, respective criteria data fields are generated, in the one or more data records, for at least two criteria of keyword, region, popularity, timing, and distance. At 276, in each criteria data field of the respective criteria data fields, data indicative of an individual score associated with the corresponding criteria is generated for a candidate point-of-interest, wherein, for the keyword, the individual score is determined based on a similarity between the information and one or more words descriptive of a name of the candidate point-of-interest, for the region, the individual score is determined based on a proximity between a first geographical region including the location of the user and a second geographical region including the candidate point-of-interest, for the popularity, based on historical data corresponding to transport-related services in one or more historical data records, the individual score is determined based on a number of time the candidate point-of-interest is historically selected as the requested location for historical transport-related services, for the timing, based on historical data corresponding to transport-related services in one or more historical data records, the historical data being associated with the user, the individual score is determined based on a probability of the candidate point-of-interest being selected by the user as the requested location at a defined time, and for the distance, the individual score is determined based on a distance between the location of the user and the candidate point-of-interest. At 278, for the each candidate data field, a resultant score is generated for the corresponding candidate point-of-interest based on the individual scores. At 280, data indicative of the resultant scores is processed. At 282, data indicative of the plurality of candidate points-of-interest is transmitted, for receipt by the user communications device, for presentation of the plurality of candidate points-of-interest, via the user communications device, in accordance with result of the processing of the data indicative of the resultant scores. In various embodiments, for the data indicative of the plurality of candidate points-of-interest to be transmitted, the plurality of candidate points-of-interest may already be ordered in accordance with the result of the processing.

In various embodiments, at 280, based on the data indicative of the resultant scores, in the one or more data records, ranking data may be generated, indicative of an ordering of the plurality of candidate points-of-interest according to the resultant scores for the plurality of candidate points-of-interest, and at 282, the data indicative of the plurality of candidate points-of-interest may be transmitted for presentation of the plurality of candidate points-of-interest, via the user communications device, in an order in accordance with the ranking data. In various embodiments, for the data indicative of the plurality of candidate points-of-interest to be transmitted, the plurality of candidate points-of-interest may already be ordered in accordance with the ranking data.

In various embodiments, at 280, based on the data indicative of the resultant scores and, for each candidate point-of-interest of the plurality of candidate points-of-interest, the resultant score may be compared against a threshold value indicative of matching relevancy of the candidate point-of-interest to the requested location, and at 282, the data indicative of the candidate points-of-interest having resultant scores determined to be equal to or above the threshold value may be transmitted.

In various embodiments, at 278, the resultant score may be generated by weighted sum of the individual scores.

In various embodiments, the at least two criteria may include the region, and, in response to the individual score for the region being determined to be indicative of the first geographical region and the second geographical region being in different countries, the method may further include excluding the candidate point-of-interest.

In various embodiments, at 274, for the each candidate data field, respective criteria data fields may be generated for at least three criteria of the keyword, the region, the popularity, the timing and the distance.

In various embodiments, at 274, for the each candidate data field, respective criteria data fields may be generated for at least four criteria of the keyword, the region, the popularity, the timing and the distance.

In various embodiments, in response to the information being at least partially descriptive of the requested location as the origin location, at 274, for the each candidate data field, respective criteria data fields may be generated for all criteria of the keyword, the region, the popularity, the timing and the distance.

Various embodiments may further provide a communications system for recommending one or more points-of-interest for a transport-related service to a user, having a communications server apparatus (e.g., 202e, FIG. 2E), at least one user communications device and communications network equipment operable for the communications server apparatus and the at least one user communications device to establish communication with each other therethrough, wherein the at least one user communications device includes a first processor and a first memory, the at least one user communications device being configured, under control of the first processor, to execute first instructions in the first memory to transmit, for receipt by the communications server apparatus for processing, user data including a first data field indicative of a location of the user, and a second data field having input data indicative of information inputted by the user, the information being at least partially descriptive of a requested location by the user as an origin location or a destination location for the transport-related service, and wherein the communications server apparatus includes a second processor and a second memory, the communications server apparatus being configured, under control of the second processor, to execute second instructions in the second memory to, in response to receiving data indicative of the user data transmitted by the at least one user communications device, generate, based on the input data, one or more data records including a plurality of candidate data fields having data for a corresponding plurality of candidate points-of-interest, generate, in the one or more data records, for each candidate data field of the plurality of candidate data fields, respective criteria data fields for at least two criteria of keyword, region, popularity, timing, and distance, generate, in each criteria data field of the respective criteria data fields, data indicative of an individual score associated with the corresponding criteria for a candidate point-of-interest, wherein, for the keyword, the individual score is determined based on a similarity between the information and one or more words descriptive of a name of the candidate point-of-interest, for the region, the individual score is determined based on a proximity between a first geographical region including the location of the user and a second geographical region including the candidate point-of-interest, for the popularity, based on historical data corresponding to transport-related services in one or more historical data records, the individual score is determined based on a number of time the candidate point-of-interest is historically selected as the requested location for historical transport-related services, for the timing, based on historical data corresponding to transport-related services in one or more historical data records, the historical data being associated with the user, the individual score is determined based on a probability of the candidate point-of-interest being selected by the user as the requested location at a defined time, for the distance, the individual score is determined based on a distance between the location of the user and the candidate point-of-interest, generate, for the each candidate data field, a resultant score for the corresponding candidate point-of-interest based on the individual scores, process data indicative of the resultant scores, and transmit, for receipt by the user communications device, data indicative of the plurality of candidate points-of-interest for presentation of the plurality of candidate points-of-interest, via the user communications device, in accordance with result of the processing of the data indicative of the resultant scores.

It should be appreciated that descriptions in the context of the communications server apparatus 202e, the method as described in the context of the flow chart 270, and the corresponding communications system described above may be applicable to one another.

The techniques disclosed above in the context of the communications server apparatus 202e, the method as described in the context of the flow chart 270 and the corresponding communications system described above may correspond to the action/scenario “Search” to be described further below. Further, said techniques may be carried out in a sequential order after the scenario “Suggest”, e.g., in the event that the results obtained from the scenario “Suggest” are not as expected or not satisfactory to the user making a request or booking for a transport-related service.

FIG. 2H shows a schematic block diagram illustrating a communications server device 202h for recommending one or more points-of-interest for a transport-related service to a user, the communications server device 202h being configured as the communications server apparatus 202a, and further configured as at least one of the communications server apparatus 202c, or the communications server apparatus 202e.

The communications server device 202h may be configured as the communications server apparatus 202a, and, thereafter (sequentially), being further configured as the communications server apparatus 202c. The communications server device 202h may be further configured, thereafter (sequentially), as the communications server apparatus 202e.

The communications server device 202h may be further configured, thereafter (sequentially), to retrieve data representative of a map including the location of the user, and transmit, for receipt by a user communications device of the user, the data representative of the map for presenting the map via the user communications device to the user for determination (e.g., based on the location of the user) of a (single) point-of-interest on the map as a recommended origin location (or pickup location) for the transport-related service.

FIG. 2I shows a flow chart 290 illustrating a method performed in a communications server device for recommending one or more points-of-interest for a transport-related service to a user, and under control of a processor of the communications server device. At 292, the method as described herein in the context of the flow chart 250 is performed. At 294, at least one of the method as described herein in the context of the flow chart 260 or the method as described herein in the context of the flow chart 270 is performed.

In various embodiments, the method as described herein in the context of the flow chart 250 may be performed, and thereafter, the method as described herein in the context of the flow chart 260 may be performed. Thereafter, the method as described herein in the context of the flow chart 270 may be performed. Thereafter, data representative of a map including the location of the user may be retrieved, and the data representative of the map may be transmitted, for receipt by a user communications device of the user, for presenting the map via the user communications device to the user for determination of a point-of-interest on the map as a recommended origin location for the transport-related service.

Various embodiments may further provide a communications system for recommending one or more points-of-interest for a transport-related service to a user, having a communications server device (e.g., 202h, FIG. 2H), at least one user communications device including a processor and a memory, and communications network equipment operable for the communications server device and the at least one user communications device to establish communication with each other therethrough, wherein the communications server device is configured as the communications server apparatus 202a, and wherein the at least one user communications device is configured, under control of the processor, to execute instructions in the memory to transmit, for receipt by the communications server device for processing, user data including a data field indicative of a location of the user, and wherein the communications server device is further configured as at least one of the communications server apparatus 202c, wherein the at least one user communications device is further configured, under control of the processor, to execute instructions in the memory to transmit, for receipt by the communications server device for processing, user data including a first data field indicative of a location, and a second data field indicative of a user request corresponding to a destination location, or, the communications server apparatus 202e, wherein the at least one user communications device is further configured, under control of the processor, to execute instructions in the memory to transmit, for receipt by the communications server device for processing, user data including a first data field indicative of a location of the user, and a second data field having input data indicative of information inputted by the user, the information being at least partially descriptive of a requested location by the user as an origin location or a destination location for the transport-related service.

There may also be provided a computer program product having instructions for implementing at least one of the methods as described herein in the context of the flow charts 250, 260, 270, 290.

There may also be provided a computer program having instructions for implementing at least one of the methods as described herein in the context of the flow charts 250, 260, 270, 290.

There may further be provided a non-transitory storage medium storing instructions, which, when executed by a processor, cause the processor to perform at least one of the methods as described herein in the context of the flow charts 250, 260, 270, 290.

In the context of various embodiments, historical data may be stored in one or more (historical) data records.

In the context of various embodiments, historical data may be stored in one or more databases.

In the context of various embodiments, historical data may be historical data (stored) for a predetermined period of time, e.g., historical data of the past 30 days.

In the context of various embodiments, a user communications device may include, but not limited to, a smart phone, tablet, handheld/portable communications device, desktop or laptop computer, terminal computer, etc.

In the context of various embodiments, the transport-related service may include or may be a ride-hailing transportation service. This may include, for example, car-hailing, and (motor)bike-hailing services.

In the context of various embodiments, the transport-related service may involve one or more autonomous vehicles.

In the context of various embodiments, an “App” or an “application” may be installed on a user communications device and may include processor-executable instructions for execution on the device. As a non-limiting example, booking of a transport-related service may be carried out via an App.

Various embodiments or techniques will now be further described in detail. Various embodiments may involve a client side as App side (frontend), and a server side (backend).

The transport service of the techniques disclosed herein may require users' pickups and dropoffs to match drivers, plan a route and compute the fare. A POI service is responsible for recommending pickups and dropoffs according to users' locations.

One measurement of the quality of the POI service is how much effort it can save from customers' (users') side to find the appropriate POIs for pickups and dropoffs.

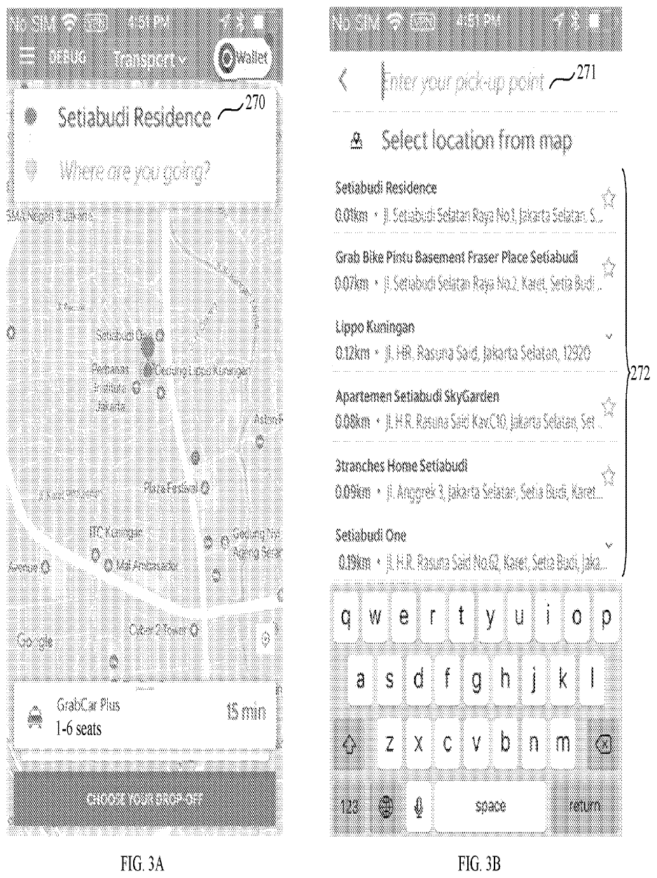

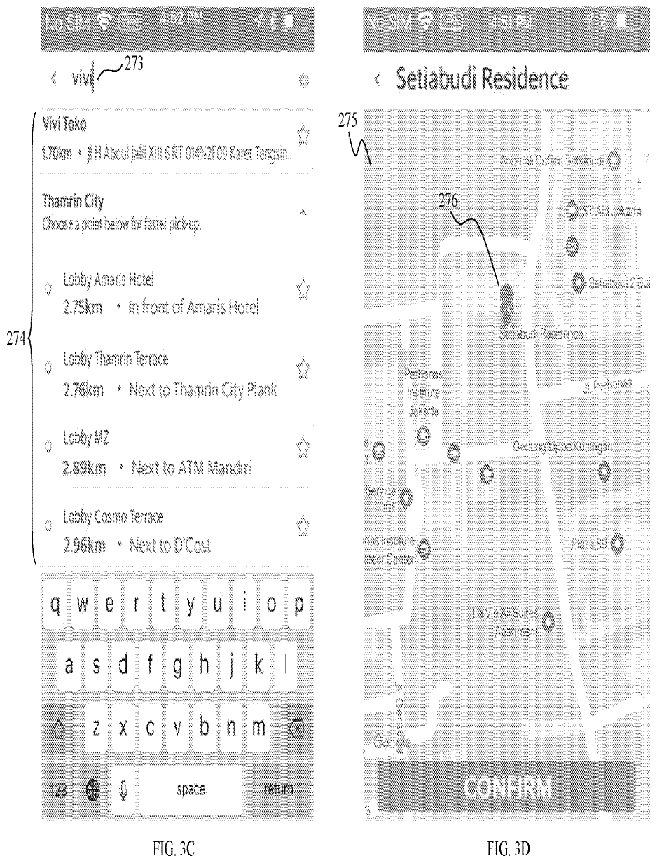

The POI service of various embodiments may include 4 major actions or scenarios in the booking flow, as shown in FIGS. 3A to 3D. These scenarios include “Predict”, “Suggest”, “Search” and “ReverseGeo”

Referring to FIG. 3A relating to the “Predict” scenario, when a user or a passenger (PAX) opens a corresponding App, the App calls a POI Predict endpoint to get a predicted pickup POI and a predicted dropoff POI based on the Pax historical data and current location. In FIG. 3A, as a non-limiting example, the predicted pickup POI 270 is shown as “Setiabudi Residence”.

In various embodiments, the Predict action is carried out at the point of opening the App. The “Predict” action will always be carried out, and is always the first action that will be carried out upon opening the App or when making a booking order.

Referring to FIG. 3B relating to the “Suggest” scenario, for example, when the predicted result is not as expected, the Pax can click the input box 271, and the App calls a POI Suggest endpoint to get a suggested list 272 of POIs based on the Pax historical data, current location, and city popular POIs.

Referring to FIG. 3C relating to the “Search” scenario, for example, when the suggested result is not as expected, the Pax can input information, for example, by typing in one or more keywords 273, and the App calls a POI Search endpoint to get a matched list 274 of POIs based on the keyword(s).

Referring to FIG. 3D relating to the “ReverseGeo” scenario, for example, when the suggested/search result is not as expected, the Pax can go to a map 275 to move a PIN 276 to call a POI ReverseGeo endpoint to find a POI.

The respective POI Predict, Suggest, Search and ReverseGeo endpoints may be located at the server side (e.g., at a communications server apparatus), or, in other words, processing in relation to the Predict, Suggest, Search and ReverseGeo scenarios may be carried out at the server side, with the results then returned to the user on the App side. The App side may provide information including one or more of Pax ID, latitude, longitude, etc. for purposes of the processing.

To sum up, the above actions or scenarios may be provided or shown in sequence to the users to discover their desired POIs for pickups and/or dropoffs. The less times the users need to click on the screen, the easier it is for them to obtain the POIs to generate a booking order. As part of generating a booking order for the whole transport service, the POI service requires high availability and stability, which may generate a lot of challenges to the system. Firstly, one challenge is how to handle concurrent requests that burst in daily peak hours while keeping the whole service stable in terms of response time. On one hand, this requires auto scaling of machines so that proper number of servers (e.g., cloud servers) are configured for different time periods per day. On the other hand, resources for each concurrent request must be managed in independent threads with properly assigned resources so that some failures won't affect the whole service to guarantee high availability. Secondly, another challenge is how to make use of volumes of historical data to provide better recommendation performance that can hit what customers want more accurately as the goal of POI service is to save the effort a user needs to get the desired pickups and/or dropoffs.

To tackle these challenges and keep the POI service highly available and stable, some techniques may be deployed as will be described below.

Elasticsearch has been utilised to store POI data and execute POI queries. Various indexes have been proposed for the management of large volume of geometry data, such as Rtree, k-d tree, or specific for moving objects to enable various of queries. Another widely used index method is Geohash, which encodes a geographic location into a short string of letters and digits and ensure that nearby places share similar prefix. In various embodiments, the internal provider makes use of elastic search to store POI data. When a request of user location (e.g., described as latitude and longitude) arrives, elastic search makes use of Geohash to return top POIs close to the given location for next step processing. It may allow scaling horizontally from one single machine to hundreds of servers with petabytes of data. To keep the response time stable with billions of POI data, the time cost of major search expressions may be analysed and the bottlenecks may be determined for specific optimisation.

Redis is a fast, open source in-memory data store for use as a database, cache, message broker, and queue. Redis may be located at the server side, for example, at a communications server apparatus. In various embodiments, the Amazon Elasticache may be adapted for Redis to cache POI data and generate cache keys in different ways according to different scenario/application requirements. This may help to control the value of query per second (QPS) to what the database behind can handle. It should be appreciated that Redis is generally located before the relevant database, for example, mySQL, dynamoDB and ElasticSearch. Generally, the logic at the server side (backend) may write request result to Redis when getting replies from the relevant database. When next time the same request occurs, replies can be directly obtained from Redis instead.

The whole backend architecture is implemented in Golang. As its parallel processing is based on goroutine and channel, each http request may be allocated to an independent goroutine to process. Even if some of them got panic, the whole process may not be affected. Goroutine is very light-weighted and easy to start and stop, which makes Golang outperform other languages in terms of stability as a backend language for various embodiments.

After analysing volumes of historical data, ranking models have been derived that may provide reasonable POI scores in different scenarios/applications. The “Cold start” challenge has also been addressed with fallbacks to provide or guarantee customer experiences for new users.

The Golang-based POI service for the techniques disclosed herein will be described in details below, including the architecture to support online POI Recommendation and discovery, POI recommendation in different scenarios, and some results of the service.

As a language released in 2009 when multi-core processors were already available, “Go” is built for concurrency. Instead of thread that consumes approximate 1 MB of the memory from the heap in java, Go has goroutines that consume around 2 KB memory so that millions of goroutines can be spinned. Besides, goroutines come with channels to communicate safely between themselves and avoid the usage of mutex locking. Go is a compiled language like C/C++. It also uses garbage collection to allocation and removal of the object like java. This may guarantee the running speed on hardwares since it may avoid the byte code interpreting of java VM step and may avoid the pain of freeing and allocating variables in languages like C/C++. Go has nice and quite stable syntax. This makes code written in Go easy to maintain. There are neither classes nor inheritance in Go. Developers could understand code easily and different code parts won't influence each other in deep. Further, developers can work together on the same code-base.

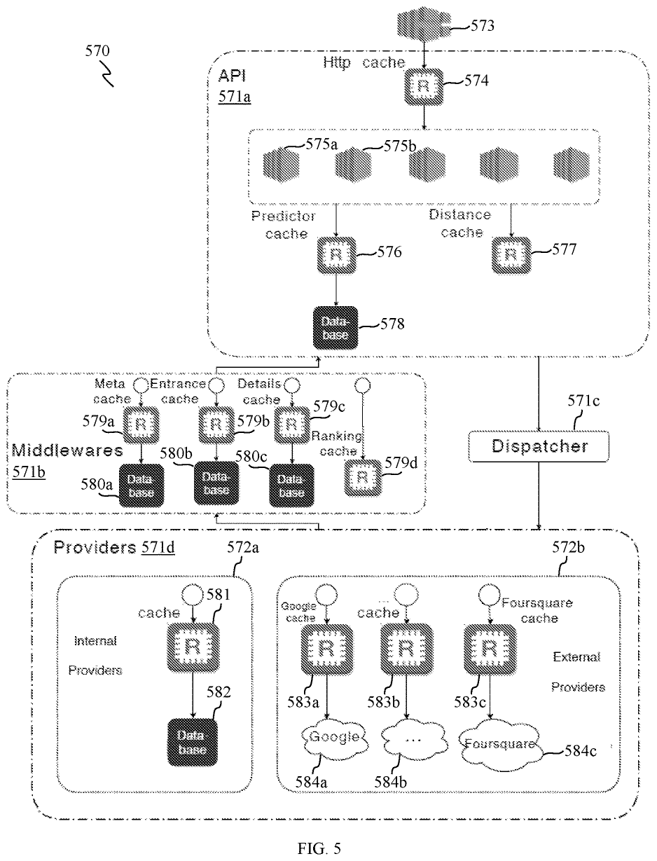

Micro service is a software development technique that structures an application as a collection of loosely coupled services. In a micro-service architecture, services are fine-grained and the protocols are lightweight. POI service is one microservice in the whole system in the various embodiments. If zoomed in to take a look, micro service like POI makes use of a multilayer service structure, as shown in FIG. 4 illustrating a layer-based web service structure 470, for example, having a http server layer 472, a logic layer 474 and a database layer 476. The http server of layer 472 is in charge of sending http requests from user side to the logic layer 474 in a load balance way. The logic layer 474 plays a role of executing processing logics according to http requests. All the data related to logic processing may be stored in the database layer 476. When the logic layer 474 runs out of computing resources, horizontal scaling such as ASG (Auto Scaling Groups) of Amazon, as a non-limiting example, may be widely used. As the logic layer 474 and data layer (i.e., database layer 476) are absolutely separated, failure of a certain logic layer instance is unlikely to lead to damage or missing of user data. The POI service of various embodiments follows such a service architecture.

For distributed systems, since that CAP (consistency, availability and partition tolerance) may not be satisfied at the same time, web services must be able to stop cascading failure and enable resilience in complex distributed systems where failure is inevitable. For the POI service, as a non-limiting example, Hystrix may be used to enable or guarantee the response time of service that is replied on by setting circuit breakers.

Since a logic layer requires user data from a data layer frequently, cache may be widely used to protect the database behind from getting down due to burst workload as well as to shorten the response time of each request. There may be two ways that may be used: one is to set a cache layer before a database layer, and the other is to set individual cache in the memory of each logic instances. For the POI service of various embodiments, Redis is adapted as the cache before the database layer and setting cache keys and expiry time according to different scenario/application requirements. Comparing to putting up cache module from scratch, making use of, for example, Amazon Elasticache for Redis, may provide elastic scaling and almost no or minimum downtime service, which may help in terms of service stability.

The POI service architecture as well as the use of cache in online POI recommendation of various embodiments will now be described by way of the following non-limiting examples.

FIG. 5 shows a schematic diagram illustrating an overview of the system 570 for POI service. The POI system 570 may be divided into four components: Firstly, API 571a is the layer to support four POI user scenarios (e.g., Predict, Suggest, Search and ReverseGeo) with the result from the middlewares layer 571b. Secondly, the dispatcher 571c dispatches http requests to the providers 571d. Thirdly, the providers 571d is the layer to get POIs from the POI providers (e.g., internal providers 572a and/or external providers 572b) and return them to the middlewares layer 571b. Fourthly, middlewares 571b is the layer to deal with the returned POIs from the providers layer 571d. The API layer 571a, the middlewares layer 571b, the dispatcher 571c and the providers layer 571d may be located at the server side (e.g., at a communications server apparatus). The API layer 571a, the middlewares layer 571b and the providers layer 571d will be further described below.

APIs 571a: There are four endpoints: Predict, Suggest, Search and ReverseGeo. Predict and Suggest are based on the Pax historical data, which may be stored in MySQL DB named Predictor DB based on the Pax 30 days' historical data. When a user or passenger opens the corresponding App, the App calls the POI Predict endpoint to get a predicted pickup POI and/or a predicted dropoff POI based on the Pax (user) historical data and the current location of the user. When the Predict result is not as expected, the Pax clicks an input box in the App, and the App calls the POI suggest endpoint to get a suggested list of POIs based on the historical data, the user current location, and the city popular POIs (i.e., the popular POIs in the city corresponding to the pickup POI and/or the dropoff POI). When the Suggest result is not as expected, the Pax types in keywords, App calls POI search endpoint to get a matched list of POIs based on the keywords. When the Suggest result is not as expected, the Pax can go to a map to move a PIN to call POI ReverseGeo endpoint to find a POI. In the context of various embodiments, the term “endpoint” may mean or refer to a module that may be called in code. Such module may include a set of instructions.

Middlewares 571b: There are several middlewares with functions such as normalizing the place ID (identifier or identification) in the received POIs from different providers 571d into unique one of uniform format, blacklisting bad POIs in the input POIs, removing duplicated POIs in the input POIs, and ranking for the input POIs based on some fields and get results in the response for both suggest and search endpoint (Predict and reverseGeo only return one POI so that there is no need to do ranking).

Providers 571d: Based on the Pax location, data related to the corresponding city may be obtained and its associated city configuration may be used. Different cities may have different configurations to determine which providers should be used. Usually, there may be two or three groups of providers, and in the same group, a search request may be sent to these providers in parallel. If all providers in the same group (e.g., first group) fail or there is no response, we send the request to the second (or subsequent) group of providers. As a non-limiting example, and depending on the configuration, the internal provider 572a and Google (external provider 572b) may be set as the first group, Foursquare (external provider 572b) as the second group, and the remaining provider(s) as the third group.

In relation to cache in online POI recommendation, as may also be seen in FIG. 5, cache may be deployed in three layers, namely the API layer 571a, the middlewares layer 571b and the providers layer 571d. The cache settings will now be described further below.

Briefly, the API layer 571a sends requests, the dispatcher layer 571c dispatches the requests to the providers 571d. The providers 571d sends back results. The middleware 571b processes the results to obtain what is desired or wanted. Finally, the results are returned to the users. Cache and database may be used to store the requests and results in the past for POI recommendation.

API layer 571a: When a http request comes into the API layer 571a (e.g., from a server 573), the first cache layer is the http cache 574 that takes the whole url as the cache key and the time-to-live (TTL) of the cache may be set to, for example, 30 seconds. This cache setting may be used for duplicated trials of the nearby users at the same places for the Search scenario (please refer to FIG. 3C and the corresponding description). Both Suggest (please refer to FIG. 3B and the corresponding description) and Search make use of distance cache 577 to store the response results in previous requests. Suggest makes use of PaxID (or user ID) and place(s) (or location(s)) (for example, in the format of latitude (lat), longitude (lng)) as the key. Search makes use of typed keyword(s) and place(s) (lat/lng) as the key. The time-to-live (TTL) of the cache 577 may be set to, for example, one day. This may allow users in the same area to share their responses. The term “time-to-live” may mean the valid time of data in cache. Invalid data cannot be used any more.

There is another cache named Predictor cache 576, which may store the pickup or dropoff of each request to Predictor DB (i.e., database storage) 578. The past 30 days historical data may be stored in the Predictor DB 578 for Predict and Suggest, as will be discussed further below. If a request to the Predictor DB 578 can be answered by the Predictor cache 576, there is no need to query the database (i.e., Predictor DB 578) behind.

In between the http cache 574, and the predictor cache 576 and the distance cache 577, there may be a group of servers (e.g., two servers are represented as 575a, 575b)

The Predictor DB 578 may be located in the database layer of a microservice (e.g., database layer 476 of FIG. 4). Generally, the logic layer 474 visits the predictor cache layer 576 first. When a miss happens, the predictor DB 578 will be visited or accessed.

The Predictor DB 578 and the predictor cache 576 are located at the server side, for example, at a communications server apparatus.

Providers layer 571d: When the request comes into the providers layer 571d, it first tries to hit the cache of each provider to get the response (e.g., internal provider cache 581, Google cache 583a, Foursquare cache 583c, and “other” (or “etc.”) cache 583b (here “other” may refer to one or more other specific providers). The TTLs of any one or all the external providers (e.g., Google 583a, Foursquare 583c and etc. 583b) may be many days. The TTL of the internal provider cache 581, which stores data from the internal provider 572a, may be 10 minutes. This may be because the POI data (e.g., in relation to addition and/or updating of discovered POIs) in the internal provider 572a may be more frequently updated and new POI data can take effect more immediately with shorter TTL. It should be appreciated that the TTL timing may be variable, depending on the frequency of updates. Also shown in FIG. 5 are the database storage 582 corresponding to the internal provider 572a, and the corresponding cloud servers 584a, 584b, 584c of external providers Google, “other”, and Foursquare.

Middlewares layer 571b: When the response of providers 571d comes into the middlewares 571b to deal with the returned POIs, there are also various caches to help process middleware functionalities. For example, a universal cache (e.g., details cache 579c) is stored in Elastic search and the TTL may be one day as POI detailed cache 579c contains POI detailed descriptions (e.g., POI name, category, location, etc.). There may be a meta cache 579a that may have TTL set to one day to store the POI status about whether the POI is blacklisted or not. Further, there may be respective caches for rank 579d and entrance 579b to store ranking and entrance information for requests. An as example, an “entrance” marks the available place of large-scale public facilities such as doors of large shopping malls and airports to get on board or dropoff a vehicle. Entrance information about accurate pickup and dropoff in these places can greatly improve the customer experience of both.

Also shown in FIG. 5 are the database storage 580a,580b, 580c corresponding to the meta cache 579a, the entrance cache 579b, the details cache 579c respectively.

Overall, a server may deal with request(s). A cache may store result(s) to avoid too many requests going to a database. A database storage may store user data. Cloud servers of providers may answer requests that are sent to them.

The online POI recommendation of various embodiments will now be further described by way of the following non-limiting examples.

In various embodiments, reverseGeo returns a POI according to the moved PIN.

In various embodiments, POI recommendation in scenarios Predict, Search, and Suggest may be performed based on historical data. Predict, Search, and Suggest may be carried out separately by making use of volumes of historical data to provide better recommendation performance that can hit what users or customers want more accurately as the goal of POI service is to save the effort a user needs to get the desired pickups and/or drop-offs. For Suggest and Predict, historical data may be stored in a database, for example, a predictor DB, and data may be provided in different tables and managed, and candidate POIs may be obtained by queries. For Search, there may be a number of aspects or considerations, for example, names keyword, region, popularity, timing and distance, to compute a weighted sum as the combined score for POI ranking. These aspects may better describe POI characteristics and help the users to find the target POI more easily. Comparing to only considering the location similarity in known techniques, this comprehensive score of various embodiments may give users a better customer experience in searching target POIs as pickups and/or dropoffs. Recommendation of the most likely points (including, e.g., pickup points) will be described below.

### Search

In the Search scenario, a user types one or more words in the input or search box and the user expects the service to provide the target POI as return. To make POIs rankable, each POI may be assigned a score, which may be determined by one or more of the following factors or criteria:

### Keyword:

This measures the score between the search keyword and the POI name or the acronyms of the POI name. Each POI may have multiple acronyms. As a non-limiting example, the keyword matching score S_{Keyword} may be computed as shown in Equation 1.

$${S}_{Keyword} = max ( {s}_{J} , {s}_{A} ) , \qquad Equation ( 1 )$$

where s_{J} is the Jaccard Similarity of the POI name and the search keyword, and s_{A} returns
1 if the search keyword exactly matches to the POI name or acronym, and 0 otherwise.

### Region:

S_{Region} measures the score based on proximity between the POI region and the Pax (or user) region. The score for S_{Region} equals to 1 if the POI region and the Pax region are the same, and 0 otherwise, as shown in Equation 2.

$${S}_{Region} = \{ \text{} \begin{matrix}1 , & if getRegion ( POI ) = getRegion ( Pax ) \\ 0 , & otherwise\end{matrix} \text{} , \qquad Equation ( 2 )$$

where getRegion(.) is a function that takes any location (lat/lng) as input and returns the corresponding city where the location is. If the POI and the Pax are in different countries, the POI will be excluded from the result list. Therefore, POIs are guaranteed to be in the same country as Pax.

### Popularity:

S_{Popularity}(*) scores the POI popularity based on the number of times that POI has been selected as the pickup/dropoff It may be defined as follows:

$${S}_{Popularity ( Pickup )} = \frac{{Count}_{Pickup}}{{Count}_{Max}} , \qquad Equation ( 3 )$$

$${S}_{Popularity ( Dropoff )} = \frac{{Count}_{Dropoff}}{{Count}_{Max}} , \qquad Equation ( 4 )$$

where Count_{Pickup} is the number of times this POI has been selected as the pickup point, Count_{Dropoff} is the number of times this POI has been selected as the dropoff, and Count_{Max} is the maximum number of times that a POI in the result set has been selected as the pickup or dropoff.

### Timing:

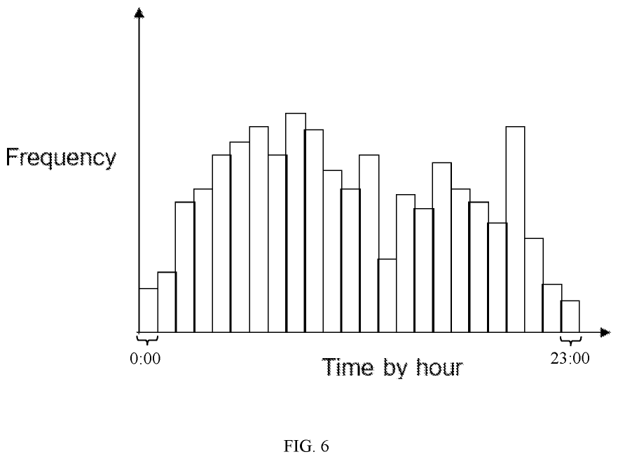

A score for a POI is defined based on the probability that a Pax or user will do a pickup or dropoff at this POI given a certain time. For instance, in the morning, a POI in the residential area is more likely to be a pickup point while with low probability to be a dropoff point. The pickup and dropoff time distribution of a POI may be pre-computed offline, and thus, the probability for the POI to become a pickup or dropoff point may be naturally derived. The detailed score may be defined as follows:

$${S}_{Timing ( Pickup )} = {Distri}_{Pickup} ( {t}_{Q} ) , \qquad Equation ( 5 )$$

$${S}_{Timing ( Dropoff )} = {Distri}_{Dropoff} ( {t}_{Q} ) , \qquad Equation ( 6 )$$

where Distri*(.) is the time distribution of a POI and t_{Q} is the query time of a Pax. As a non-limiting example, in various embodiments, the time distribution of a POI may be implemented by a map (see FIG. 6), where key is the time (hour from 0:00 to 23:00, representing the corresponding 24 hours of a day; see X-axis of FIG. 6) and value (which refers to “frequency” in FIG. 6) is the ratio the POI has been selected as the pickup or dropoff point in the history, and is therefore related to how many times the POI has been selected as the pickup or dropoff point at a given or defined time.

### Distance:

This measures the score based on the distance between the POI and the Pax's location. This factor is applicable to pickup search only. It may be defined by

$${S}_{Distance ( Pickup )} = 1 / ( 1 + {e}^{( 2 * ( dist - 2 ) )} ) , \qquad Equation ( 7 )$$

where the distance, dist, may be measurable, for example, in km (kilometre).

The final score may then be computed by weighted sum as follows:

$$S = {\sum }_{i ∈ [ 0 , 5 ] , f ∈ F} {α}_{i} {S}_{f} , \qquad Equation ( 8 )$$

where the weighting factors ai are determined by a machine learnt algorithm, and F is the set of factors identified above, i.e., keyword, region, popularity, timing, distance. Then, POIs may be ranked according to their respective scores in a descending order, for example. Only recommended POIs are listed on the App screen for presentation to the user or Pax.

### Suggest

In the Suggest scenario, a suggested list of POIs for pickup and dropoff may be obtained by a Pax (user) by clicking on the input box of the corresponding App. As pickups may usually be POIs near to the Pax location while dropoffs may usually be popular places where the Pax needs to go, pickup and dropoff may be considered separately.

### Pickup:

Two sources may be used for pickup.

Firstly, a database (e.g., Predictor DB) may be used, where the database may store 30 days historical data by managing a table about POI preference. It stores Pax ID and the corresponding pickups in the past. This allows querying historical pickups in the past by Pax ID.

Secondly, the POI service may have an internal module named “Nearby” It takes Pax location (lat/lng) as input and returns nearby POIs according to the distance by calling different Providers (see, for example, the Providers layer 571d of FIG. 5) according to configuration. In various embodiments, configuration defines the priority of different providers for the service to make a request. For example, referring to FIG. 5, the internal provider 572a and google (as part of external provider 572b) may be set as the first group of providers to query, and, if there are no satisfactory results, a second group, for example, foursquare (as part of external provider 572b) may be queried.

By considering these two sources, both personal preference of the Pax and distance between the Pax location and POI may be considered, which may improve the accuracy of the pickup(s) suggested.

### Dropoff:

Two sources may be used for dropoff.

Firstly, another table that stores most frequently used dropoffs (MFU dropoffs) by Pax ID in the database (e.g., Predictor DB) may be used. This allows querying most frequently used dropoffs by Pax ID.

Secondly, the top categories in Redis may be used. It stores the top popularly categorised POIs (e.g., food, shop mall, airport, etc.) in the various cities and can be queried by city ID.

By considering these two sources, both personal preference of the Pax and common preference of others may be suggested, which may improve the accuracy of the dropoff(s) suggested.

### Predict

In the Predict scenario, a predicted pickup and/or a predicted dropoff may be provided to fill in the booking order. Similarly, pickup and dropoff may be considered separately.

### Cold Start:

For a new Pax (user) without any old booking history, Predict may use the location (lat/lng) to call reverseGeo as the fallback to address or overcome the cold start problem. ReverseGeo takes the Pax location as the PIN on the map to find a nearest POI for the Pax.

### Pickup:

For a Pax with some booking histories, there may be two sources for pickup prediction, for example, last dropoff first (LDF) and tables in a database (e.g., Predictor DB). The user's previous pickup POIs stored in the database may be used. This can be done by querying the Pax ID and wifi SSID (service set identifier) to obtain the previous pickup POIs. That is to say, places where a Pax used to appear in the past may be recommended as pickup in prediction. If no record is found in the database (e.g., Predictor DB), LDF may be used. LDFs are the Pax's last time dropoffs during the last 24 hours. For both predictor DB and LDF, the POI that is nearest to the user location is returned. If all of the POIs are out of a certain (or threshold) distance, reverseGeo may then be relied upon.

LDF may come from another (micro)service that accesses a database (e.g., booking DB), different from the Predictor DB, to obtain the last dropoff of a Pax. A booking DB may be located or stored in MySQL. The booking DB may be located at the server side, for example, at a communications server apparatus. The booking DB may store booking information, for example, one or more of booking code, timestamp, passenger ID, pickup and dropoff, etc.

### Dropoff:

For dropoff prediction, a table in a database (e.g., Predictor DB) that pairs dropoffs with pickups of each passenger (or user) by hours in a day may be used. Given any Pax ID and time period, the pair of pickup and droppoff may be obtained by queries easily. The dropoff in the past that pairs with the same pickup may be used as the dropoff prediction for the Pax. That is to say, in dropoff prediction, it may be assumed that people are likely to follow their daily routines. The same dropoff the Pax selected in the past booking(s) during the same time period of the day may be recommended.

The performance of the POI service in a production environment will now be described. The production environment settings and the metrics to measure the performance will first be described, and, then, the performance result according to the metrics of the POI service will be described.

### Production Environment Setting and Measurement Metrics

The configuration of the POI service is Amazon c5.4xlarge EC2 instances. For c5.4xlarge instances, Amazon provides 16 virtual CPU cores and 32G memory. The storage is EBS-only and the dedicated EBS Bandwidth is 3,500 Mbps. Besides, up to 10 Gbps bandwidth is provided for network performance. Elasticache of Amazon is used for cache to implement the online POI recommendation.

To measure the stability of the POI service in different scenarios/applications, the round trip time (RTT) is shown, that equals to the duration from a request sent to the response returned. To better describe RTT, measurement is made in terms of the 95 percentile and the 99 percentile. The less RTT varies between peak hours and non-peak hours, the more stable the system is.

With the use of cache in the system, and referring to FIG. 5, the effectiveness of cache is measured in terms of cache hit ratio in the API 571a, Middleware 571b and Provider 571d layers. For the API layer 571a, the Predictor cache 576 used in the Predict scenario is taken as a non-limiting example. For the Middleware layer 571b, the meta cache 579a for blacklist checking is used as a non-limiting example. For the Provider layer 571f, cache 581, 583a for internal provider and Google are shown on behalf of internal providers 572a and external providers 572b respectively.

### Performance Results

The performance of the POI service will be shown and described in three aspects according to the measurement metrics mentioned above. Firstly, an overall performance during one day is provided. Then, the performance of round-trip-time (RTT) of scenarios Predict, Suggest, Search and ReverseGeo is shown. Finally, the usage of cache in the POI service is shown.

### Overall Performance of POI Service:

Based on statistics, the query per second (QPS) of the POI service varies during the day. The periods of 7:00 am to 9:00 am and 17:00 μm to 20:00 pm are defined as peak hours. The peak QPS value generally appears around 6:00 pm. QPS becomes very low at midnight. The average QPS is around 200 per instance. The CPU usage varies with QPS as expected. The highest CPU usage per day is controlled under 60%. In terms of goroutines, more QPS results in more goroutines generated and leading to increasing CPU usage. The average value of number of goroutines is around 1.2 k per instance. Memory usage is stable during the whole day around the value of 25G per instance.

### Performance of POI Service in Various Scenarios/Applications:

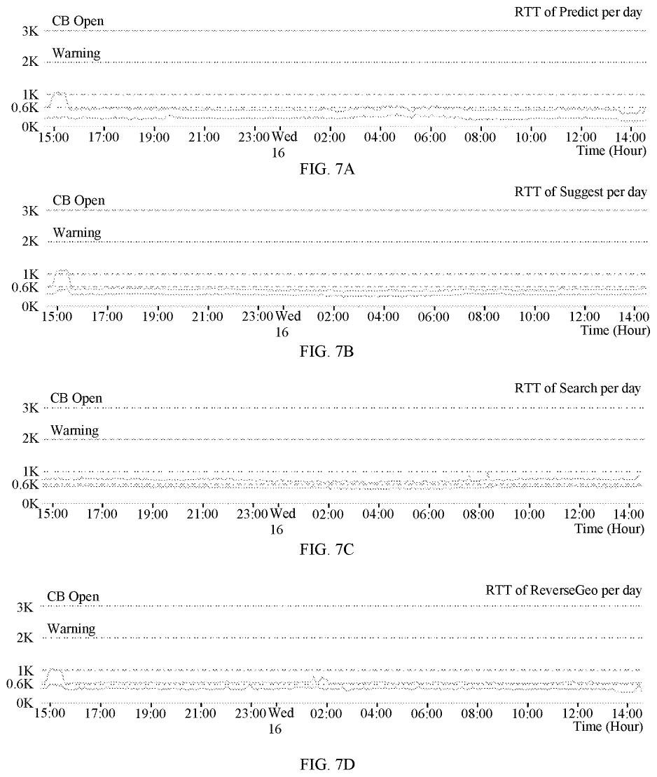

FIGS. 7A to 7D show the RTT of scenarios Predict, Suggest, Search and ReverseGeo respectively. The Y-axis in FIGS. 7A to 7D represent the round-trip-time (RTT) in unit “ms”. The label “Wed 16” in the X-axis in FIGS. 7A to 7D refers to the start of a new day of a certain month, which is the 16th day and it being a Wednesday.

In FIGS. 7A to 7D, the respective dashed lines indicated as “Warning” and “CB Open” refers respectively to the time threshold for service safety, and time threshold where the service cannot reply requests in the required time and could be treated as unresponsive.

As may be observed, two solid lines are shown for each of FIGS. 7A to 7D. The upper solid line represents “P99”, i.e., the 99-percentile of the statistical data, while the lower solid line represents “P95”, i.e., the 95-percentile of the statistical data.

As may be observed for Search in FIG. 7C, the RTT in terms of the 95 percentile and the 99 percentile are respectively 500 ms and 730 ms. RTT is stable no matter how the QPS changes along with time in a day. Further, the results for Predict in FIG. 7A, Suggest in FIG. 7B and ReverseGeo in FIG. 7D show similar stability in terms of RTT. The 95 percentile/99 percentile of RTT varies in each scenario, as may be seen in Table 1 below. The logic of Search and ReverseGeo involves querying external providers (e.g., Google or Foursquare) or Elastic Search, which results in a longer RTT compared to Predict and Suggest.

TABLE 1
RTT of different scenarios.

| | Predict | Suggest | Search | ReverseGeo |
|---|---|---|---|---|
| 95 Percentile | 320 ms | 190 ms | 500 ms | 490 ms |
| 99 Percentile | 560 ms | 300 ms | 730 ms | 700 ms |

### Performance of Cache in POI Service:

Table 2 shows the cache hit ratio averaged in one day for the Predictor DB cache 576 (for API layer 571a), meta cache 579a (for middleware layer 571b), internal provider cache 581 (as internal provider 572a) and Google cache 583a (as external provider 572b). As may be observed, the high cache hit ratio in the predictor DB cache 576 and the meta cache 579a shows the effectiveness of cache usage in terms of minimising or avoiding duplicate requests to database. For the provider layer 571d, the cache hit ratio of the internal provider cache 581 is much lower than that of the external provider Google cache 583a. This is because the internal provider is frequently updated and the TTL of its cache 581 is much shorter than that of the external providers 572b.

TABLE 2
Cache hit ratio of cache in different layers

| | InternalTop | Google | Meta | Predictor DB |
|---|---|---|---|---|
| Cache hit ratio | 7.94% | 89.03% | 94.21% | 76.66% |

As described above, there may be provided a technique for point-of-interest (POI) recommendation in real time. For transport services (such as ride-hailing services), for example, when making or generating a booking order (e.g., through an App), a user may go through one or more actions to find his desired POIs for pickups and/or drop-offs. These action(s) may include (i) “Predict” where a predicted pickup POI and/or a predicted dropoff POI are made based on at least one of the user's historical data or current location; (ii) “Suggest” where the user clicks on an input field to get a suggested list of POIs based on at least one of the user's historical data, current location, or the relevant city's popular POIs; (iii) “Search” where the user types in information, e.g., keywords, such that a matched list of POIs based on the keywords is provided; and (iv) “ReverseGeo” where the user may go to a map to move a PIN to find a POI. These actions may be independent of each other. These actions may occur in any order, or may occur in a sequence order, for example, “Predict” may first be performed, followed by “Suggest” when the predicted result is not as expected, “Search” when the suggested result is not as expected and “Reverse-Geo” when the suggested/search result is not as expected. The booking flow may be defined in the order of using Predict/Suggest/Search/ReverseGeo so as to find the POIs as pickup or dropoff The order may be based on how much a user's efforts (measured by number of clicks on the screen/App) may be saved or minimised.

Nevertheless, it should be appreciated that it may not be necessary for all four actions to occur per any one booking order. In other words, any one, two or three or all of the actions, Predict, Suggest, Search, ReverseGeo, may be performed during the course of a user making a booking order for a transport-related service. As a non-limiting example, a user may choose to skip any action or step so as to use any of the actions freely, e.g., after Predict, the user may directly jump to ReverseGeo without going through Suggest and/or Search.

In various embodiments, the actions of Predict, Suggest and Search may be carried out separately by making use of historical data to provide better recommendation performance to get the desired pickups and dropoffs. For Suggest and Predict, historical data may be stored in a database, e.g., a predictor database, in different tables. For Search, one or more aspects/criteria: names keyword, region, popularity, timing and distance, may be considered to compute a resultant score, e.g., a weighted sum as the combined score, for POI ranking.

For Search, a final score by weighted sum may be computed using the scores of the following criteria for each POI, with the POIs then ranked according to their scores in descending order, with a list of recommended POIs subsequently provided to the user:
(i) Keyword: A score is provided on the basis of the search keyword and the POI name or acronyms of the POI name, with a higher score when there is closeness or a match;
(ii) Region: A score is provided based on the relevancy or proximity between the user's region (e.g., country) and the POI region, with a score of “1” when the two regions are the same, and “0” otherwise (where the corresponding POI is then excluded from the search list);
(iii) Popularity: A score is provided based on the number of times the POI has been selected as the pickup (for pickup search) or dropoff (for dropoff search), with a higher score when there is a higher number of times the POI has been selected;
(iv) Timing: A score is defined based on the probability that a user will have a pickup or dropoff at a particular POI given a certain time, with a higher score when there is a higher probability of the POI being a pickup (for pickup search) or dropoff (for dropoff search) for that particular time that a transport service is required;
(v) Distance (applicable only for pickup search): A score is provided based on the distance between the POI and the user's location, with a higher score when the distance is less.

For Suggest, by clicking the relevant input field (e.g., in an App), lists of suggested POIs for pickup and dropoff are provided. As pickups are usually POIs near to the user location while dropoff are usually popular places where the user needs to go, pickup and dropoff are considered separately. In terms of pickup, two sources may be considered, namely: (i) A database (e.g., predictor database) storing 30 days historical data about POI preference, in a table storing the user ID and the corresponding pickups in the past. This allows querying historical pickups in the past by user ID; (ii) The user location (latitude/longitude) is used as input and nearby POIs are then provided according to distance. Accordingly, both personal preference of the user and the distance between the user Pax location and POI may be considered, thereby improving the accuracy of pickups suggested. In terms of dropoff, two sources may be considered, namely: (i) a database (e.g., predictor database) storing data relating to most frequently used drop-offs (MFU dropoffs) by user ID in a separate table. This allows querying most frequently used dropoffs by user ID; (ii) Top popularly categorized POIs (e.g., food, shop mall, airport, etc.) in various cities and can be queried by city ID. Accordingly, both personal preference of the user and the general common preferences may be suggested, thereby improving the accuracy of dropoffs suggested.

For Predict, a pickup may be predicted and/or a dropoff may be predicted to fill in the booking order. Similar to Suggest, pickup and dropoff may be considered separately. In terms of pickup where the user has historical booking data, two sources may be considered for pickup prediction, namely last dropoff first (LDF) and tables with data in a database (e.g., predictor database). LDF are the user's last time dropoffs during 24 hours. If there is no LDF for the Pax, the user's previous pickup POIs stored in the database (predictor DB) may be used. This may be done by querying the user Pax ID and wifi SSID to obtain the previous pickup POIs. That is to say, places where a user used to appear in the past may be recommended as pickup in the prediction. In terms of dropoff where the user has historical booking data, a table in a database (e.g., predictor database) that pairs dropoffs with pickups of each user by hours in a day may be used. Given a user ID and time period, the pair of pickup and droppoff may be obtained by queries. The dropoff in the past that pairs with the same pickup may be used as the dropoff prediction for the user. That is to say, in dropoff prediction, it may be assumed that people are likely to follow their daily routines. The same dropoff the user selected in the past booking during the same time period of the day may be recommended. In situations of “Cold start” for a new user without any historical booking data, the location (latitude/longitude) of the user may be used as the PIN on a map to find a nearest POI for the user (similar to “ReverseGeo” above).

As also described above, the POI (point of interest) service of various embodiments may be built with Golang-based microservice architecture. The online challenges may be addressed by deploying techniques according to appropriate or unique scenarios or applications.

The POI service may help to increase the ratio of completed bookings while saving passengers' efforts in finding an appropriate pickup point and/or dropoff point. It will be appreciated that any one of Predict, Suggest, or Search may potentially be customised according to habits or preferences of the users (or passengers). Further, the time cost of internal modules of the system may be optimised.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server comprising:
a memory storing instructions; and
a processor configured to execute the instructions to:
receive user data from a user communications device associated with a user upon activation of a transport application executing on the user communications device, the user data including a data field indicative of a location of the user;
determine whether there is historical data, associated with the user, corresponding to transport-related services in one or more data records; and
in response to determining that there is historical data, associated with the user, corresponding to transport-related services in the one or more data records:
access a prediction endpoint of the communications server to determine, based on the historical data and the location, a first point-of-interest as a recommended origin location for a transport-related service, wherein the prediction endpoint includes a predictor cache and a predictor database behind the predictor cache, the predictor cache storing point-of-interest (POI) data of each POI request made to the predictor database within a predetermined time period;
determine, based on the historical data and the access of the prediction endpoint, a second point-of-interest as a recommended destination location for the transport-related service, the first point-of-interest and the second point-of-interest being paired to each other corresponding to a historical transport-related service in the historical data, wherein, for accessing the prediction endpoint, the processor is configured to query the predictor cache prior to querying the predictor database, and wherein in the event that the first point-of-interest and the second point-of-interest are determined in response to querying the predictor cache, the processor is configured to avoid querying the predictor database; and
transmit, to the user communications device, data indicative of the first point-of-interest and the second point-of-interest.

2. The communications server of claim 1, wherein the processor is configured to execute the instructions to:
receive, from the user communications device, information indicating one of: (i) an acceptance of the first point-of-interest and the second point-of-interest, and (ii) an issuance of a suggest request upon selection of an input element in the transport application executing on the user communications device by the user;
populate an order, being made by the user for the transport-related service, with the first point-of-interest and the second point-of-interest, in response to receiving the information indicating the acceptance;
access a suggest endpoint of the communications server to retrieve a suggested list of points-of-interest in response to receiving the information indicating the issuance of the suggest request, wherein accessing the suggest endpoint causes at least one of:
the processor to query the predictor database storing the historical data to retrieve one or more first candidate points-of-interest for inclusion in the suggested list of points-of-interest; and
a dispatcher module of the communications server to dispatch a request in parallel to one or more provider modules configured to retrieve one or more second candidate points-of-interest from one or more external data sources for inclusion in the suggested list of points-of-interest;
transmit, to the user communications device, data indicative of the suggested list of points-of-interest;
receive, from the user communications device, information indicating a pickup point-of-interest and a drop-off point-of-interest selected, by the user via the transport application, from the suggested list of points-of-interest; and
populate an order, being made by the user for the transport-related service, with the pickup point-of-interest and the drop-off point-of-interest selected by the user from the suggested list of points-of-interest.

3. The communications server of claim 1, wherein the processor is configured to execute the instructions to:
in response to determining that there is no historical data, associated with the user, corresponding to transport-related services in the one or more data records:
retrieve data representative of a map comprising the location; and
transmit, for receipt by the user communications device, the data representative of the map for presenting the map via the user communications device to the user for determination of a point-of-interest on the map for the transport-related service.

4. The communications server of claim 1, wherein the user data comprises a data field indicative of a time, and wherein the processor is configured to execute the instructions to:
determine, based on the historical data, the second point-of-interest being paired to the first point-of-interest in a predetermined time interval comprising the time.

5. The communications server of claim 1, wherein, for determining the first point-of-interest, the processor is configured to execute the instructions to:
determine whether there is data indicative of one or more historical origin locations for transport-related services comprised in the historical data;
in response to determining that there is data indicative of the one or more historical origin locations in the historical data:
define, based on the data indicative of the one or more historical origin locations, a historical origin location that is the closest in distance to the location of the user as the first point-of-interest; and
in response to determining that there is no data indicative of the one or more historical origin locations in the historical data:
determine data indicative of one or more historical destination locations comprised in the historical data; and
define, based on the data indicative of the one or more historical destination locations, a historical destination location that is the closest in distance to the location of the user as the first point-of-interest.

6. The communications server of claim 5, wherein, for determining the data indicative of the one or more historical destination locations, the processor is configured to execute the instructions to determine the data indicative of the one or more historical destination locations associated with a predetermined historical period of time.

7. The communications server of claim 2, wherein the suggest request corresponds to an origin location, and wherein, for retrieving the suggested list of points-of-interest, the processor is configured to execute the instructions to:
determine, based on the access of the suggest endpoint, the one or more first candidate points-of-interest as one or more historical origin locations included in the historical data associated with the user; and
determine, based on the access of the suggest endpoint, the one or more second candidate points-of-interest that are within a predetermined distance relative to the location of the user.

8. The communications server of claim 2, wherein the suggest request corresponds to a destination location, and wherein, for retrieving the suggested list of points-of-interest, the processor is configured to execute the instructions to:
determine, based on the access of the suggest endpoint, the one or more first candidate points-of-interest as one or more historical destination locations that are most frequented by the user according to the historical data; and
determine, based on the access of the suggest endpoint, the one or more second candidate points-of-interest as one or more top ranking points-of-interest in at least one destination category in a geographical area comprising the location.

9. A method, executed by a processor of a communications server, for recommending one or more points-of-interest for a transport-related service to a user, the method comprising:
receiving user data from a user communications device associated with the user, the user data including a first data field indicative of a location of the user, and a second data field indicative of a suggest request issued upon selection of an input element by the user in a transport application executing on the user communications device;
accessing a suggest endpoint of the communications server to retrieve a suggested list of points-of-interest in response to receiving the user data, wherein accessing the suggest endpoint causes at least one of:
the processor to query historical data, associated with the user, corresponding to transport-related services in one or more data records, wherein the processor queries the historical data to retrieve one or more first candidate points-of-interest for inclusion in the suggested list of points-of-interest; and
a dispatcher module of the communications server to dispatch a request in parallel to one or more provider modules configured to retrieve one or more second candidate points-of-interest from one or more external data sources for inclusion in the suggested list of points-of-interest;
transmitting, to the user communications device, data indicative of the suggested list of points-of-interest;
receiving, from the user communications device, information indicating a pickup point-of-interest and a drop-off point-of-interest selected, by the user via the transport application, from the suggested list of points-of-interest; and
populating an order, being made by the user for the transport-related service, with the pickup point-of-interest and the drop-off point-of-interest selected by the user from the suggested list of points-of-interest.

10. The method of claim 9, wherein the suggest request corresponds to an origin location, and wherein retrieving the suggested list of points-of-interest comprises:
determining, based on the access of the suggest endpoint, the one or more first candidate points-of-interest as one or more historical origin locations included in the historical data associated with the user; and
determining, based on the access of the suggest endpoint, the one or more second candidate points-of-interest that are within a predetermined distance relative to the location of the user.

11. The method of claim 9, wherein the suggest request corresponds to a destination location, and wherein retrieving the suggested list of points-of-interest comprises:
determining, based on the access of the suggest endpoint, the one or more first candidate points-of-interest as one or more historical destination locations that are most frequented by the user according to the historical data; and
determining, based on the access of the suggest endpoint, the one or more second candidate points-of-interest as one or more top ranking points-of-interest in at least one destination category in a geographical area comprising the location.

12. A communications system comprising a user communications device associated with a user and a communications server,
wherein the user communications device comprises a first memory storing first instructions, and a first processor configured to execute the first instructions to operate a transport application executing thereon to transmit, to the communications server, user data comprising a data field indicative of a location of the user; and
wherein the communications server comprises a second memory storing second instructions, and a second processor configured to execute the second instructions to:
in response to receiving the user data from the user communications device, determine whether there is historical data, associated with the user, corresponding to transport-related services in one or more data records; and
in response to determining that there is historical data, associated with the user, corresponding to transport-related services in the one or more data records:
access a prediction endpoint of the communications server to determine, based on the historical data and the location, a first point-of-interest as a recommended origin location for a transport-related service, wherein the prediction endpoint includes a predictor cache and a predictor database behind the predictor cache, the predictor cache storing point-of-interest (POI) data of each POI request made to the predictor database within a predetermined time period;
determine, based on the historical data and the access of the prediction endpoint, a second point-of-interest as a recommended destination location for the transport-related service, the first point-of-interest and the second point-of-interest being paired to each other corresponding to a historical transport-related service in the historical data, wherein, for accessing the prediction endpoint, the second processor is configured to query the predictor cache prior to querying the predictor database, and wherein in the event that the first point-of-interest and the second point-of-interest are determined in response to querying the predictor cache, the second processor is configured to avoid querying the predictor database;
transmit, to the user communications device, data indicative of the first point-of-interest and the second point-of-interest;
receive, from the user communications device, information indicating one of: (i) an acceptance of the first point-of-interest and the second point-of-interest, and (ii) an issuance of a suggest request by the user;
populate an order, being made by the user for the transport-related service, with the first point-of-interest and the second point-of-interest, in response to receiving the information indicating the acceptance;
access a suggest endpoint of the communications server to retrieve a suggested list of points-of-interest in response to receiving the information indicating the issuance of the suggest request, wherein accessing the suggest endpoint causes at least one of:
the second processor to query the predictor database storing the historical data to retrieve one or more first candidate points-of-interest for inclusion in the suggested list of points-of-interest; and
a dispatcher module of the communications server to dispatch a request in parallel to one or more provider modules configured to retrieve one or more second candidate points-of-interest from one or more external data sources for inclusion in the suggested list of points-of-interest;
transmit, to the user communications device, data indicative of the suggested list of points-of-interest;
receive, from the user communications device, information indicating a pickup point-of-interest and a drop-off point-of-interest selected, by the user via the transport application, from the suggested list of points-of-interest; and
populate an order, being made by the user for the transport-related service, with the pickup point-of-interest and the drop-off point-of-interest selected by the user from the suggested list of points-of-interest.

13. The communications system of claim 12, wherein the second processor is configured to execute the second instructions to:
in response to determining that there is no historical data, associated with the user, corresponding to transport-related services in the one or more data records:
retrieve data representative of a map comprising the location; and
transmit, for receipt by the user communications device, the data representative of the map for presenting the map via the user communications device to the user for determination of a point-of-interest on the map for the transport-related service.

14. The communications system of claim 12, wherein the user data comprises a data field indicative of a time, and wherein the second processor is configured to execute the second instructions to:
determine, based on the historical data, the second point-of-interest being paired to the first point-of-interest in a predetermined time interval comprising the time.

15. The communications system of claim 12, wherein, for determining the first point-of-interest, the second processor is configured to execute the second instructions to:
determine whether there is data indicative of one or more historical origin locations for transport-related services comprised in the historical data;
in response to determining that there is data indicative of the one or more historical origin locations in the historical data:
define, based on the data indicative of the one or more historical origin locations, a historical origin location that is the closest in distance to the location of the user as the first point-of-interest; and
in response to determining that there is no data indicative of the one or more historical origin locations in the historical data:
determine data indicative of one or more historical destination locations comprised in the historical data; and
define, based on the data indicative of the one or more historical destination locations, a historical destination location that is the closest in distance to the location of the user as the first point-of-interest.

16. The communications system of claim 15, wherein, for determining the data indicative of the one or more historical destination locations, the second processor is configured to execute the second instructions to determine the data indicative of the one or more historical destination locations associated with a predetermined historical period of time.

17. The communications system of claim 12, wherein the suggest request corresponds to an origin location, and wherein, for retrieving the suggested list of points-of-interest, the second processor is configured to execute the second instructions to:
determine, based on the access of the suggest endpoint, the one or more first candidate points-of-interest as one or more historical origin locations included in the historical data associated with the user; and
determine, based on the access of the suggest endpoint, the one or more second candidate points-of-interest that are within a predetermined distance relative to the location of the user.

18. The communications system of claim 12, wherein the suggest request corresponds to a destination location, and wherein, for retrieving the suggested list of points-of-interest, the second processor is configured to execute the second instructions to:
determine, based on the access of the suggest endpoint, the one or more first candidate points-of-interest as one or more historical destination locations that are most frequented by the user according to the historical data; and
determine, based on the access of the suggest endpoint, the one or more second candidate points-of-interest as one or more top ranking points-of-interest in at least one destination category in a geographical area comprising the location.

19. The communications system of claim 12, wherein the first processor is configured to execute the first instructions to:
receive, from the communications server, the data indicative of the first point-of-interest and the second point-of-interest;
display, on an interface of the user communications device, the data indicative of the first point-of-interest and the second point-of-interest;
detect a selection, by the user, of an element in the transport application executing on the user communications device, wherein the element is selectable to accept the first point-of-interest and the second point-of-interest; and
transmit, to the communications server, the information indicating the acceptance of the first point-of-interest and the second point-of-interest based on the selection of the element by the user.

20. The communications system of claim 12, wherein the first processor is configured to execute the first instructions to:
receive, from the communications server, the data indicative of the first point-of-interest and the second point-of-interest;
display, on an interface of the user communications device, the data indicative of the first point-of-interest and the second point-of-interest;
detect a selection, by the user, of an input element in the transport application executing on the user communications device, wherein the input element corresponds to the suggest request; and
transmit, to the communications server, the information indicating the issuance of the suggest request based on the selection of the input element by the user.
